(19) United States
(12) Patent Application Publication
(10) Pub. No.: US 2020/0018272 A1
(43) Pub. Date: Jan. 16, 2020

(54) ENGINE AIR INDUCTION RESISTIVE FOAM ELEMENT SOUND ABSORBER AND SILENCER

(71) Applicant: Ford Global Technologies, LLC, Dearborn, MI (US)

(72) Inventors: Scott M. Rollins, Canton, MI (US); John Emley, Canton, MI (US); Roger Joseph Khami, Troy, MI (US)

(73) Assignee: Ford Global Technologies, LLC, Dearborn, MI (US)

(21) Appl. No.: 16/031,445

(22) Filed: Jul. 10, 2018

(51) Int. Cl. F02M 35/12; F02M 35/10; C08L 75/04; C08L 23/16; C08L 33/18

(52) U.S. Cl. CPC F02M 35/1272; F02M 35/1294; C08L 33/18; C08L 75/04; C08L 23/16; F02M 35/10334

(57) ABSTRACT

A tunable, noise-attenuating resistive silencer assembly for use with an internal combustion engine is disclosed. The resistive silencer assembly incorporates a resistive silencer material. The assembly includes an intake duct having air inlet and outlet ends, an acoustic absorbing material support structure positioned between the air inlet and air outlet ends, and an acoustic absorbing element supported by the acoustic absorbing material support structure. The acoustic absorbing element has a defined and non-amorphous shape. The air enters the air inlet end, passes by the acoustic absorbing material, and exits the air outlet end. The acoustic absorbing element is formed from a foam material that may be open cell or closed cell. If open cell foam, the material may be either a low density or high density polyurethane foam. If closed cell foam, the material may be crushed, closed-celled ethylene propylene dieme or polyvinyl nitrile foam.

### TECHNICAL FIELD

The disclosed inventive concept relates generally to air intake systems for internal combustion engines. More particularly, the disclosed inventive concept relates to sound absorbing and silencing systems for use with such air intake systems. The sound absorbing and silencing system of the disclosed inventive concept incorporates a resistive foam element preferably of the closed cell type.

### BACKGROUND OF THE INVENTION

Automobile designers are today challenged by a broad range of requirements externally imposed by customer demands at one extreme and by government regulation at the other. One such customer demand is for the reduction of overall vehicle noise, vibration and harshness (NVH). A known source of vehicle noise in the internal combustion engine is air induction noise created by the engine and controlled by the air induction system.

In an effort to minimize air induction noise, automotive designers and engineers incorporated an acoustic absorbing material in the air intake passage. The common sound absorbing material is loose non-woven polyester batting. A fine mesh screen is required in the design of the material supporting structure such as a plastic retainer cage retain or restrict the entrainment of the loose polyester fiber from the air stream into the turbocharger inlet. Contaminating debris can damage the turbocharger at an expense to the manufacturer or to the end customer. The fine meshed screen is insert-molded to a plastic retainer cage. The retainer cage with its insert molded screen is assembled to the interior of an engine intake air duct.

The fine meshed screen has been found to be sensitive to mechanical cycling fatigue. Accordingly, a premium screen material must therefore be used. This method and combination of materials is effective for vehicle life durability.

However, use of the plastic retainer cage and screen to contain the loose non-woven polyester batting is cost-prohibitive due to the material cost (largely due to the expense of fine mesh screen) and the cost involved in the requisite over-molding operation of the screen material to the plastic cage. In addition, the installation of a specific amount of the loose polyester fiber batting is a labor-intensive undertaking.

Once in operation, the loose polyester fiber batting material can become soaked with liquid, typically oil or water, which can compact the loose acoustic material over time. The compaction of the batting can create voids in the resonator volume as it moves out of its intended original position. This reduces the acoustic performance of the resistive silencer component assembly. The loose batting acoustic material does not recover its position, size or shape if or when the polyester is dried over time.

Accordingly, known approaches to attenuating air induction noise associated with the operation of an internal combustion engine have not provided completely satisfactory results. As in so many areas of vehicle technology, there is always room for improvement related to air induction noise reduction.

### SUMMARY OF THE INVENTION

The disclosed inventive concept provides a noise-attenuating resistive silencer assembly for use with an internal combustion engine. The resistive silencer assembly incorporates a resistive silencer material. The type, amount, and shape of the silencer material may be adapted for a particular use, thereby offering to the vehicle designer a high degree of tunability so as to achieve the desired level of noise emitted through the air induction system.

The noise-attenuating resistive silencer assembly of the disclosed inventive concept includes an intake duct having air inlet and outlet ends, an acoustic absorbing material support structure operatively associated with the intake duct and positioned between the air inlet end and the air outlet end, and an acoustic absorbing element supported by the acoustic absorbing material support structure. The acoustic absorbing element has a defined and non-amorphous shape. The intake duct may be of any of several shapes adapted for use in any one of several arrangements in relation to any of several internal combustion engines. However, regardless of the application, the air enters the air inlet end, passes by the acoustic absorbing material, and exits the air outlet end.

The acoustic absorbing element is formed from a shaped foam material which has a defined shape that is not subject to becoming loose or dissembling, unlike known batting. The shape of the foam material is defined to be placed in an acoustic absorbing element support structure. It may be a single layer or may be multiple layers. The foam material may be open cell foam or closed cell foam. A combination of open cell foam materials and closed cell foam materials may be utilized. In the case of open cell foam, the material may be, as a non-limiting example, either a low density or high density polyurethane foam. In the case of closed cell foam, the material may be, as non-limiting examples, crushed, closed-celled ethylene propylene dieme or polyvinyl nitrile foam.

The noise-attenuating resistive silencer assembly of the disclosed inventive concept provides an effective and efficient response to the need to reduce air induction noise in the internal combustion engine. The noise-attenuating resistive silencer assembly is relatively inexpensive to produce, install, and maintain.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 is a perspective view of an internal combustion engine having an air intake system according to the disclosed inventive concept that incorporates a resistive silencer assembly according to the disclosed inventive concept;

FIG. 2 is a perspective view of a variation of the resistive silencer assembly shown in isolation according to the disclosed inventive concept;

FIG. 3 is an exploded view of a housing assembly for an acoustic absorber material for use in the resistive silencer assembly of FIG. 2;

FIG. 4 is partial sectional view of the inlet end of the housing assembly of FIG. 3;

FIG. 5 is a perspective view of another variation of the resistive silencer assembly shown in isolation according to the disclosed inventive concept;

FIG. 6 is a perspective view of an acoustic material support frame according to a variation of the disclosed inventive concept;

FIG. 7 is a side view of the acoustic absorbing material support frame of FIG. 6;

FIG. 8 is an underside view of the acoustic absorbing material support frame of FIG. 6; and

FIG. 9 is the acoustic absorbing material support frame similar to that of FIG. 8 but illustrating an acoustic absorbing material in place on the underside of the support frame.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

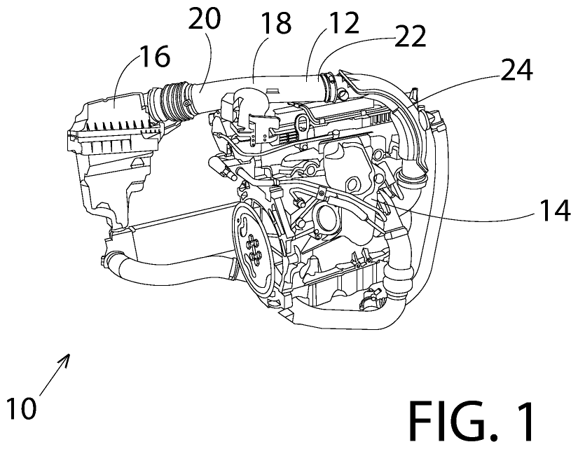

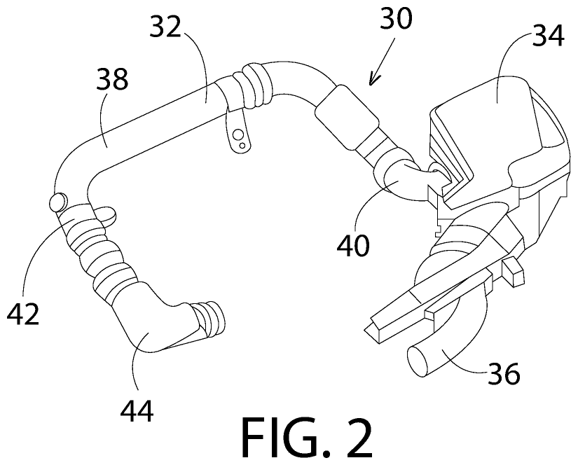

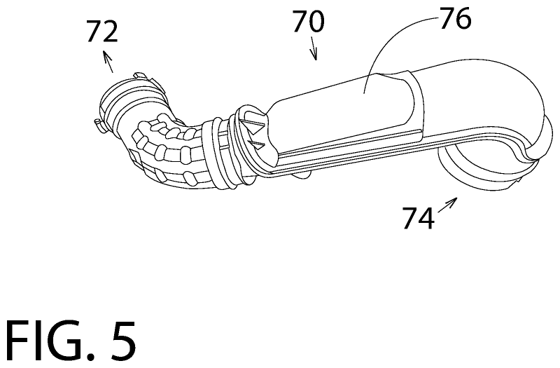

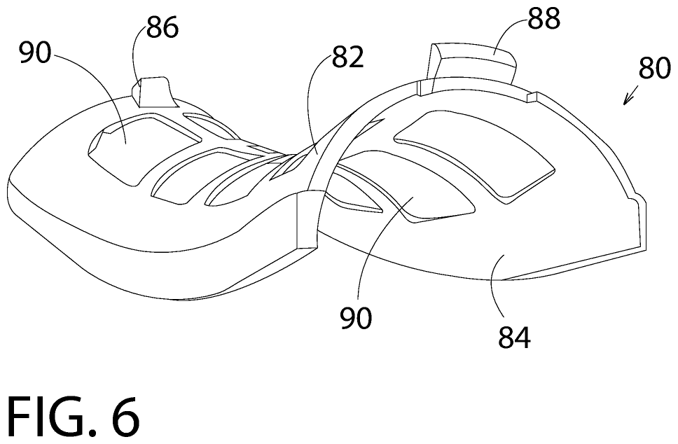

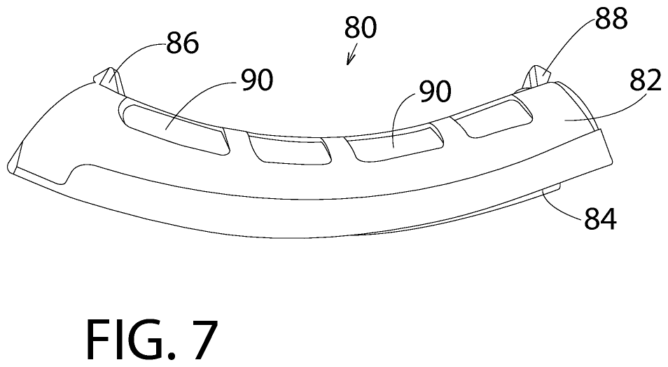

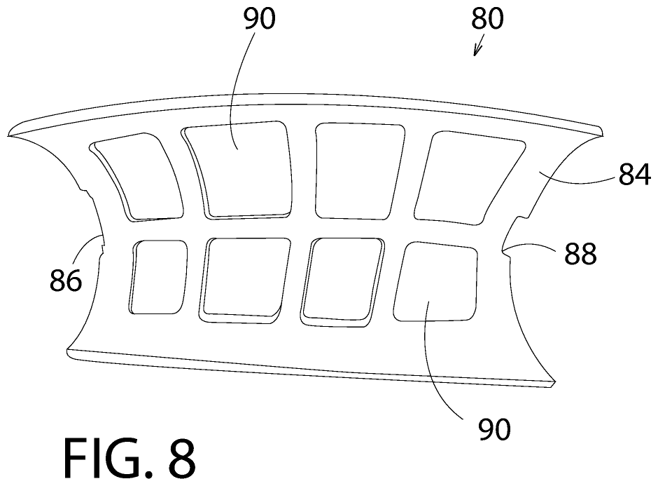

The accompanying figures and the associated description illustrate a resistive silencer assembly that may be adapted for use in any number of applications beyond the automotive industry. Particularly, FIG. 1 illustrates an exemplary engine having an air intake system fitted thereto which incorporates the resistive silencer assembly of the disclosed inventive concept. FIGS. 2 through 4 illustrate an air intake assembly that incorporates the resistive silencer material of the disclosed inventive concept. FIG. 5 illustrates an alternative variation of an air intake duct that incorporates the resistive silencer material of the disclosed inventive concept. And FIGS. 6 through 9 illustrate various views of a support frame for retaining the resistive silencer material for use in an air intake according to the disclosed inventive concept. It is to be understood that the illustrated support frame is only suggestive and is not intended as being limiting as the resistive silencer material of the disclosed inventive concept may be supported by a wide array of support structures.

In general, the disclosed inventive concept provides superior short and long term performance over the known technologies in large part due to the advantages of incorporating a foam block of acoustic absorbing material into the resistive silencer assembly. The foam block of acoustic absorbing material of the disclosed inventive concept has a defined and non-amorphous form that does not lose its shape over time and does not degrade or release particles that could damage intake components, such as the vehicle's turbocharging system. Use of the foam block of acoustic absorbing material as part of the resistive silencer assembly results in significant material and production cost savings without compromising acoustic performance when compared with conventional acoustic batting. Air enters the system, passes by (but not through) the acoustic absorbing material, and exits the system for entrance into the induction unit, such as a turbocharger.

Referring to FIG. 1, a perspective view of an internal combustion engine, generally illustrated as 10, is shown. It is to be understood that the illustrated internal combustion engine 10 is suggestive only as the resistive silencer assembly of the disclosed inventive concept may be adapted for use with a wide variety of internal combustion engines.

The internal combustion engine 10 conventionally includes an air intake system 12. The air intake system 12 draws fresh ambient air at one end, passes the air, and exhausts the fresh air into the engine's intake. Particularly, a turbocharger 14 or a similar forced air induction device is fitted to the air intake of the internal combustion engine 10. The turbocharger 14 receives air from the air intake system 12. An incoming air box 16 is fitted to an air intake duct 18. The incoming air box 16 conventionally includes an air filter. The air intake duct 18 includes an air intake end 20 and an air output end 22. The incoming air box 16 is attached to the air intake end 20 of the air intake duct 18 while the turbocharger 14 is attached to the air output end 22 of the air intake duct 18.

An air inlet duct silencer 24 is formed as part of the air intake system 12. The air inlet duct silencer 24 includes a resistive silencer material that is restrained in a support frame or other structure that restrains the resistive silencer material at one side of the air duct work of the air intake system 12. By being positioned off to the side of the airflow, the incoming air passes by but not through the resistive silencer material, thereby minimizing any interference with airflow while providing superior noise absorbing characteristics.

The acoustic absorbing material used as silencing material in the disclosed inventive concept may be any of several elastomeric materials including, but not limited to, any of several open cell or closed cell foam materials. Non-limiting examples of such materials include any of several closed-cell polyurethane foam materials. Both types of foam materials have air pockets defining individual cells. Non-limiting examples of open cell foam materials include open cell polyurethane foam. The open cell foam may be high density or low density.

Non-limiting examples of closed cell foam include any of several polyurethane foam materials. A preferred material is crushed, closed-celled EPDM (ethylene propylene dieme) which is a synthetic rubber that is capable of withstanding extremes of cold and heat. Crushed, closed-cell EPDM foam is preferred as it is highly flexible and is capable of filling voids. Another closed cell foam material suitable for use in the disclosed inventive concept is closed cell polyvinyl nitrile foam (PVN).

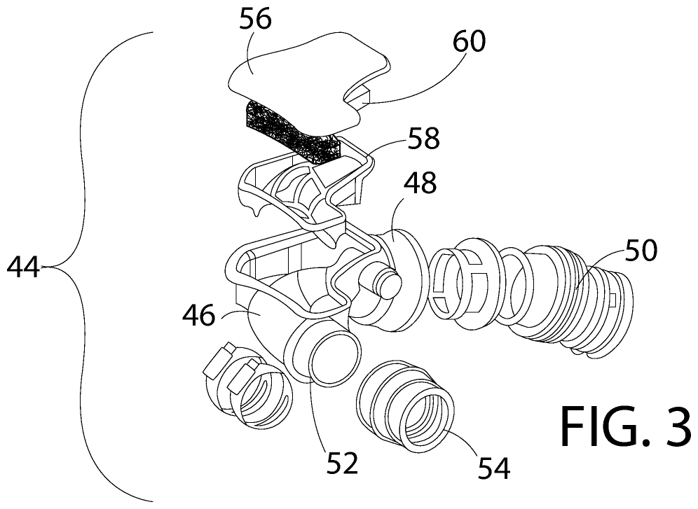

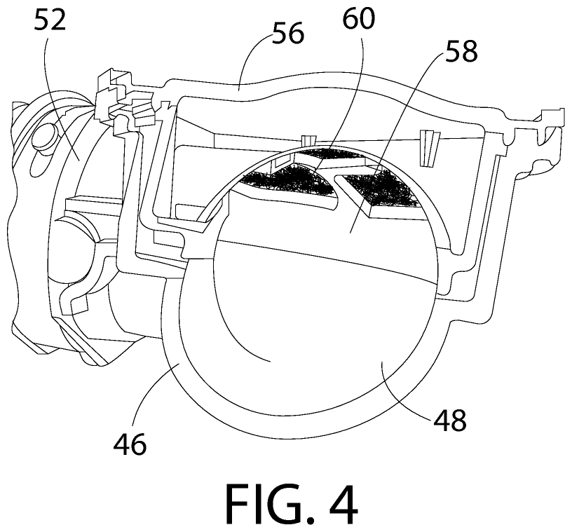

The block of acoustic absorbing material 60 illustrated in FIGS. 3 and 4 may be selected from any one of several materials discussed above. As noted, these materials include, but are not limited to, any of several open cell foam materials or closed cell foam materials. It is also possible for these different materials to be used in combination such that one or more layers of an open cell foam material may be combined with one or more layers of closed cell foam material. Because of its defined material, the block of acoustic absorbing material 60 can be shaped to fit within the defined space of the acoustic absorbing material support structure.

Referring to FIG. 2, a perspective view of an air intake assembly having a resistive silencer is illustrated in isolation. The air intake assembly, generally illustrated as 30, includes an air output assembly 32 associated with an air box 34. The air box 34 includes an air box intake 36. The air box intake 36 draws in ambient fresh air for engine combustion. The air intake assembly 30 further includes an air intake duct 38 having an Intake air duct intake end 40 and an intake air duct output end 42. A resistive silencer assembly 44 is attached to the intake air duct output end 42. It is to be understood that the illustrated air intake assembly 30 is suggestive only as other system configurations having a resistive silencer may be adapted without deviating from the spirit or scope of the disclosed inventive concept.

The resistive silencer assembly 44 is illustrated in exploded view in FIG. 3. It is to be understood that the resistive silencer assembly 44 illustrated in FIG. 3 is only suggestive and is not intended as being limiting as other shapes and sizes may be adopted without deviating from the spirit and scope of the disclosed inventive concept.

With reference thereto, the resistive silencer assembly 44 includes a resistive silencer housing 46 having a housing inlet 48 to which is attached a housing inlet hose 50. The resistive silencer housing 46 further includes a housing outlet to which is attached a housing outlet hose 54. A removable resistive silencer housing cover 56 is adapted for enclosing the resistive silencer housing 46.

Within the resistive silencer housing 46 is provided an acoustic absorbing material support frame 58 that provides support to a block of acoustic absorbing material 60. The acoustic absorbing material support frame 58 may be made of any suitable polymerized material that resists extreme temperatures and petroleum products.

The block of acoustic absorbing material 60 may be selected from any one of several materials including, but not limited to, any of several open cell foam materials or closed cell foam materials. Both types of foam materials have air pockets defining individual cells. Non-limiting examples of open cell foam materials include open cell polyurethane foam. The open cell foam may be high density or low density.

Non-limiting examples of closed cell foam include any of several polyurethane foam materials. A preferred material is crushed, closed-celled EPDM (ethylene propylene dieme) which is a synthetic rubber that is capable of withstanding extremes of cold and heat. Crushed, closed-cell EPDM foam is preferred as it is highly flexible and is capable of filling voids. Another closed cell foam material suitable for use in the disclosed inventive concept is closed cell polyvinyl nitrile foam (PVN).

Regardless of its composition, the block of acoustic absorbing material 60 offers several advantages over known batting. First, a predetermined block of foam material may be standardized for each application, thereby minimizing or virtually eliminating variations in the amount of sound absorbing material required. Second, because the foam block does not have a significant amount of loose fine particles, the requirement for a fine mesh screen to be added to the absorbing material support frame is eliminated thus saving both material and production costs related to the application of the screen to the support frame. Third, unlike batting which is subject to changes in size, shape, and position over its life, the foam block of acoustic absorbing material 60 can be relied upon to maintain its original configuration for the life of the vehicle.

Referring to FIG. 4, a partial sectional view of the housing inlet 48 of the resistive silencer housing 46 of FIG. 3 is illustrated. A portion of the acoustic absorbing material 60 is visible supported by the acoustic absorbing material support frame 58. As illustrated in FIG. 4, the incoming air passes by but not through the acoustic absorbing material 60.

Referring to FIG. 5, a perspective view of another variation of the resistive silencer assembly shown in isolation according to the disclosed inventive concept is illustrated. The silencer assembly, generally illustrated as 70, includes an air duct outlet 72 which is attached to an air intake component of the engine, such as a turbocharger, and an air duct inlet 74, which is attached to an air inlet, such as an air box. Attached to the silencer assembly is a resistive silencer assembly 76.

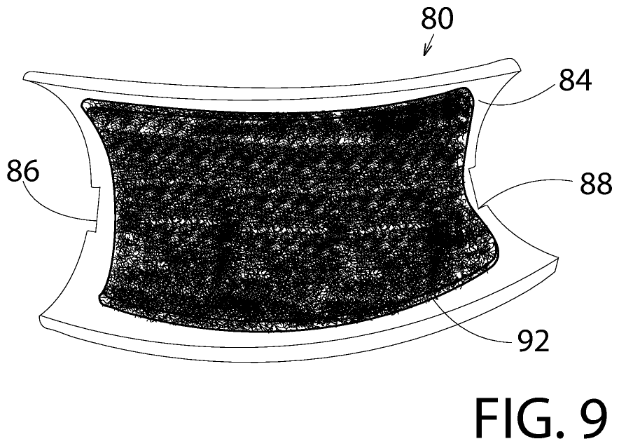

Within the resistive silencer assembly 76 is provided an acoustic absorbing support frame similar in both structure and function to the acoustic absorbing material support frame 58 of FIG. 3. An acoustic absorbing support frame suitable for use in the resistive silencer assembly 76 is illustrated in FIGS. 6 through 8 while the support frame is illustrated with an exemplary acoustic absorbing material in FIG. 9.

With reference to FIGS. 6 through 8, an acoustic material absorbing support frame, generally illustrated as 80, is shown in perspective, side, and underside views respectively. The acoustic material absorbing support frame 80 includes an outer side 82, an inner side 84, and attachment clips 86 and 88. The acoustic material absorbing support frame 80 may be made of any suitable polymerized material that resists extreme temperatures and petroleum products.

Formed in the acoustic material absorbing support frame 80 is a plurality of windows 90. The windows permit the acoustic absorption of sound as the intake air passes by the acoustic material absorbing support frame 80.

FIG. 9 illustrates an acoustic absorbing material 92 in position on the inner side 94 of the acoustic absorbing material support frame 80. The acoustic absorbing material 92 may be either open cell or closed cell foam as discussed above with respect to the acoustic absorbing material 60.

The noise attenuating intake assembly of the disclosed inventive concept provides a solution to the difficulty of controlling noise in the air induction system of an internal combustion engine. The intake assembly set forth herein is of relatively low cost for not only initial production and installation but also provides virtually no needed maintenance over the life of the vehicle. In addition, the noise attenuating intake assembly of the disclosed inventive concept provides a high degree of tunability for controlling noise levels. Such tunability is enabled through the selection of specific types of resistive silencer material. Selections include the desired density of the material and whether or not the material is of the closed cell or open cell type. Accordingly, optimum air induction noise tuning is customizable according to vehicle and engine package.

One skilled in the art will readily recognize from the above discussion, and from the accompanying drawings and claims, that various changes, modifications and variations can be made therein without departing from the true spirit and fair scope of the invention as defined by the following claims.

What is claimed is:

1. A noise attenuation device for an internal combustion engine air induction system, comprising:
an intake duct having air inlet and outlet ends;
an acoustic absorbing material support structure operatively associated with said intake duct and positioned between said ends; and
an acoustic absorbing element supported by said support structure, said acoustic absorbing element having a defined and non-amorphous shape, whereby air enters said inlet, passes by said acoustic absorbing material, and exits said outlet.

2. The noise attenuation device of claim 1, wherein said acoustic absorbing element is formed from a foam material.

3. The noise attenuation device of claim 2, wherein said foam material is open cell foam.

4. The noise attenuation device of claim 3, wherein said open cell foam is polyurethane foam.

5. The noise attenuation device of claim 3, wherein said open cell foam is selected from the group consisting of high density foam and low density foam.

6. The noise attenuation device of claim 2, wherein said foam material is closed cell foam.

7. The noise attenuation device of claim 6, wherein said closed cell foam is polyurethane foam.

8. The noise attenuation device of claim 6, wherein said closed cell foam is crushed, closed-celled ethylene propylene dieme.

9. The noise attenuation device of claim 6, wherein said closed cell foam is polyvinyl nitrile foam.

10. A noise attenuation device for an internal combustion engine air induction system, comprising:
an intake duct having air inlet and outlet ends;
an acoustic absorbing material support structure operatively associated with said intake duct and positioned between said ends; and
an acoustic absorbing element supported by said support structure, said acoustic absorbing element being formed from a foam material, whereby air enters said inlet, passes by said acoustic absorbing material, and exits said outlet.

11. The noise attenuation device of claim 10, wherein said foam material is open cell foam.

12. The noise attenuation device of claim 11, wherein said open cell foam is polyurethane foam.

13. The noise attenuation device of claim 11, wherein said open cell foam is selected from the group consisting of high density foam and low density foam.

14. The noise attenuation device of claim 10, wherein said foam material is closed cell foam.

15. The noise attenuation device of claim 14, wherein said closed cell foam is polyurethane foam.

16. The noise attenuation device of claim 14, wherein said closed cell foam is crushed, closed-celled ethylene propylene dieme.

17. The noise attenuation device of claim 14, wherein said closed cell foam is polyvinyl nitrile foam.

18. A noise attenuation device for an internal combustion engine air induction system, comprising:
an intake duct having air inlet and outlet ends;
an acoustic absorbing material support structure operatively associated with said intake duct and positioned between said ends; and
an acoustic absorbing element supported by said support structure, said acoustic absorbing element being formed from a having air pockets, whereby air enters said inlet, passes by said acoustic absorbing material, and exits said outlet.

19. The noise attenuation device of claim 18, wherein said acoustic absorbing element is open cell foam.

20. The noise attenuation device of claim 18, wherein said acoustic absorbing element is closed cell foam.
